(19) United States
(12) Patent Application Publication
(10) Pub. No.: US 2014/0310385 A1
(43) Pub. Date: Oct. 16, 2014

(54) METHOD AND SERVER FOR PUSHING MEDIA FILE

(71) Applicant: TENCENT TECHNOLOGY (SHENZHEN) COMPANY LIMITED, Shenzhen (CN)

(72) Inventor: XIAOLONG ZHANG, Shenzhen (CN)

(73) Assignee: TENCENT TECHNOLOGY (SHENZHEN) COMPANY LIMITED, Shenzhen (CN)

(21) Appl. No.: 14/135,606

(22) Filed: Dec. 20, 2013

Related U.S. Application Data
(63) Continuation of application No. PCT/CN2013/075074, filed on May 2, 2013.

(30) Foreign Application Priority Data
Apr. 16, 2013 (CN) 201310132935.0

(51) Int. Cl. H04L 29/12

(52) U.S. Cl. CPC H04L 61/1582
USPC 709/219

(57) ABSTRACT

Various embodiments provide a method and server for pushing a media file. In an exemplary method, a first media file can be received and stored on a server. A first media identifier (ID) unique to the first media file can be assigned by the server. One or more third-party service providers selected from a plurality of third-party service providers can be obtained to receive the first media file. The first media ID can be pushed to the selected one or more third-party service providers. An exemplary server can include a receiving and storing module, an assigning module, a selecting module, and/or a pushing module for pushing the media file.

### CROSS-REFERENCES TO RELATED APPLICATIONS

This application is a continuation application of PCT Patent Application No. PCT/CN2013/075074, filed on May 2, 2013, which claims priority to Chinese Patent Application No. CN201310132935.0, filed on Apr. 16, 2013, the entire contents of which are incorporated herein by reference.

### FIELD OF THE DISCLOSURE

The present disclosure relates to the field of information transmission and, more particularly, relates to a method for pushing media file and a server for executing the method.

### BACKGROUND

With development of Internet, more and more people use the Internet to obtain and publish all kinds of information, which is quick and convenient. A user may use a browser on a personal computer, a smart phone, a handheld computer, a netbook, or any other communication terminals to access the Internet and to visit desired service platforms. Information to be published may be uploaded to a service platform and shared by other users via the service platform.

Conventionally, every time when publishing information, corresponding information link addresses and source files have to be provided with large information volume, especially for a multimedia file. The multimedia file generally includes big files, the uploading process of which may therefore be affected by network bandwidth, environmental factor, etc. Consequently, the uploading speed is slow and a large amount of network resources has to be taken up. In addition, every time when using a different service platform, the entire multimedia file needs to be uploaded. Such uploading process consumes more network resources, wasting the network resources.

### BRIEF SUMMARY OF THE DISCLOSURE

According to various embodiments, there is provided a method for pushing a media file. In this method, a pushed first media file can be received and stored. A first media identifier (ID) unique to the pushed first media file can be assigned. One or more third-party service providers selected from a plurality of third-party service providers can be obtained to receive the pushed first media file. The first media ID can be pushed to the selected one or more third-party service providers.

According to various embodiments, there is also provided a server for pushing a media file. An exemplary server can include a receiving and storing module, an assigning module, a selecting module, and a pushing module. The receiving and storing module can be configured to receive and store a pushed first media file. The assigning module can be configured to assign a first media identifier (ID) unique to the pushed first media file. The selecting module can be configured to select one or more third-party service providers from a plurality of third-party service providers to receive the pushed first media file. The pushing module can be configured to push the first media ID to the selected one or more third-party service providers.

As disclosed, by storing the first media file and assigning the first media ID unique to the first media file, when pushing the same first media file to a desired number of third-party service providers, the disclosed methods and servers only need to push the first media ID to the third-party service provider(s). There is no need to upload the first media file every time when pushing the first media file. This one-time uploading or pushing of the first media file reduces data volume of network transmission, consumes less network resources, and saves the network resources. Further, there is no need for a user to provide external links to the first media file. Operational processes are thus simplified.

Other aspects or embodiments of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1 depicts an exemplary method for pushing a media file in accordance with various disclosed embodiments;

FIG. 2 depicts a flow diagram for regularly deleting a first media file in accordance with various disclosed embodiments;

FIG. 3 depicts another exemplary for pushing a media file in accordance with various disclosed embodiments;

FIG. 4 depicts a flow diagram for regularly deleting a second multimedia file in accordance with various disclosed embodiments;

FIG. 5 depicts a flow diagram for receiving and storing a pushed first media file in accordance with various disclosed embodiments;

FIG. 6 depicts an exemplary server for executing a method for pushing a media file in accordance with various disclosed embodiments;

FIG. 7 depicts an exemplary receiving and storing module in accordance with various disclosed embodiments;

FIG. 8 depicts another exemplary server in accordance with various disclosed embodiments;

FIG. 9 depicts another exemplary server in accordance with various disclosed embodiments;

FIG. 10 depicts an exemplary environment incorporating certain disclosed embodiments; and

FIG. 11 depicts an exemplary computing system in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

Various embodiments provide a method and server for pushing a media file. In an exemplary method, a first media file can be received and stored on a server. A first media identifier (ID) unique to the first media file can be assigned by the server. One or more third-party service providers selected from a plurality of third-party service providers can be obtained to receive the first media file. The first media ID can be pushed to the selected one or more third-party service providers. An exemplary server can include a receiving and storing module, an assigning module, a selecting module, and/or a pushing module for pushing the media file.

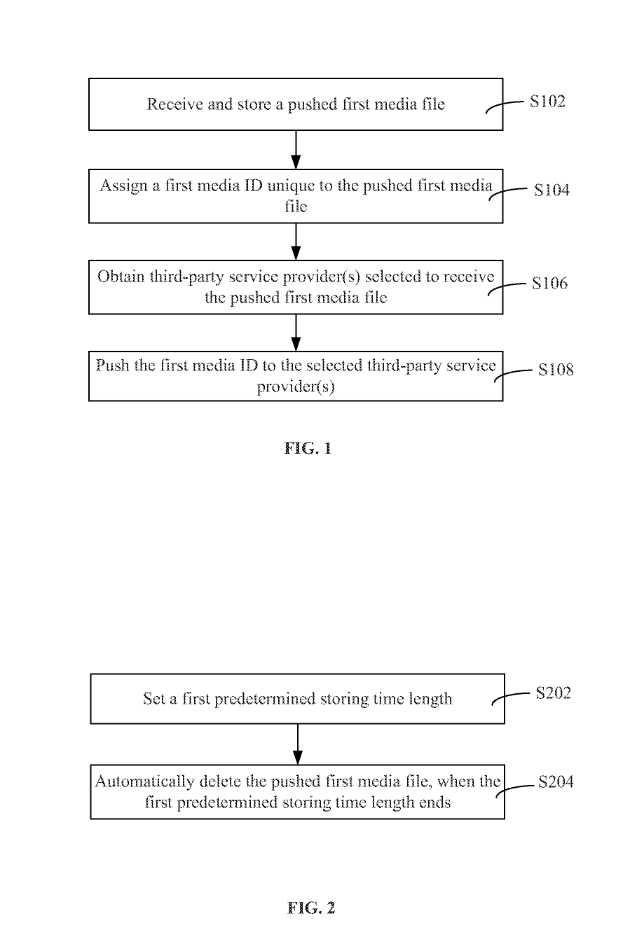

FIG. 1 depicts an exemplary method for pushing a media file in accordance with various disclosed embodiments. The exemplary method may be used on a personal computer, a smart phone, a PDA (i.e., personal digital assistant), a netbook, a tablet pad, a tablet computer, a handheld computer, and/or any suitable communication devices.

In Step S102, a pushed first media file is received and stored, e.g., by a server. For example, a user may use a browser/software installed on a communication device or a client terminal to register with a server of a public platform (or a public platform server) and to obtain a user registration account. Via the browser and/or any software, the user can login to the public platform server using the user registration account and a password. The user may upload a first media file via the browser and/or software (e.g., in the client terminal) to the public platform server. When the public platform server receives the uploaded first media file, the first media file can be stored on the public platform server.

The first media file may include, for example, a multimedia file, a rich media file, and/or any other suitable files. Exemplary multimedia file may include various kinds of files, such as, for example, one or more files of an image file, an audio file, a video file, and/or an audio/video file, contained in a message uploaded by a user to the public platform server. For example, the multimedia file may include personal pictures of a user, user's own video(s), others' video(s), videos for sceneries, etc. Exemplary rich media file may include one or more files of an image file, a carton (or animation) file, a text file including for example a HTML (Hypertext Markup Language) file, and/or files of Javascripts, Realvideo, Realaudio, and/or Flash.

In various embodiments, the public platform can provide third-party service provider(s) with a base platform as a common interface. Such public platform can include, for example, an instant communication platform such as a Wechat platform, a microblog platform, or any other suitable platforms.

FIG. 2 depicts a flow diagram for regularly deleting the first media file (e.g., at regular intervals) in accordance with various disclosed embodiments.

In Step S202, a first predetermined storing time length is set. For example, the first predetermined storing time length can be determined by a storage space and properties of the public platform server. The first predetermined storing time length can be, for example, about 3 days, about 7 days, or any other time length as desired.

In Step S204, the first media file is automatically deleted, when one first predetermined storing time length ends. By regularly deleting the stored first media file (e.g., the multimedia file) from the public platform server, the storage space of the public platform server can be saved, and the server storage function can be maintained.

Referring back to FIG. 1, in Step S104, a first media identifier (ID) unique to the first media file is assigned. After the public platform server has stored the first media file, the public platform server can assign the first media ID. The first media ID can be a first media numbering, e.g., V0001, or other suitable numberings. In one embodiment when the user uploads multiple media files (e.g., including one or more of a multimedia file, a rich media file, etc.), the public platform server may assign one first media ID unique to each one media file of the multiple media files. In another embodiment when the first media file is a multimedia file, a unique first multimedia ID can be assigned. In another embodiment when the first media file is a rich-media file, a unique first rich-media ID can be assigned.

In Step S106, third-party service provider(s) selected to receive the first media file is obtained, e.g., by the public platform server. For example, the third-party service provider(s) can be registered with the public platform server to obtain a corresponding service account. After the user logins to the public platform server, a plurality of third-party service providers may be displayed on an interactive interface of the public platform. The plurality of third-party service providers can be displayed as a list. The public platform server can obtain information of one or more third-party service provider(s) that the user selected from the plurality of third-party service providers. The selected one or more third-party service provider(s) can be used to receive the first media file sent by the user.

In Step S108, the first media ID is pushed to the selected third-party service provider(s). For example, after the first media ID has been pushed to the selected third-party service provider(s), the selected third-party service provider(s) can obtain the first media file corresponding to the pushed first media ID from the public platform server.

As such, by storing the first media file and assigning the first media ID unique to the first media file, when pushing the same first media file to a desired number of third-party service providers, the disclosed method as depicted in FIG. 1 only needs to push the first media ID to the third-party service provider(s). There is no need to upload the first media file every time when pushing the first media file. This one-time uploading of the first media file reduces data volume for network transmission, consumes less network resources, and saves the network resources. Further, there is no need for the user to provide external links to the first media file. Operational processes are thus simplified.

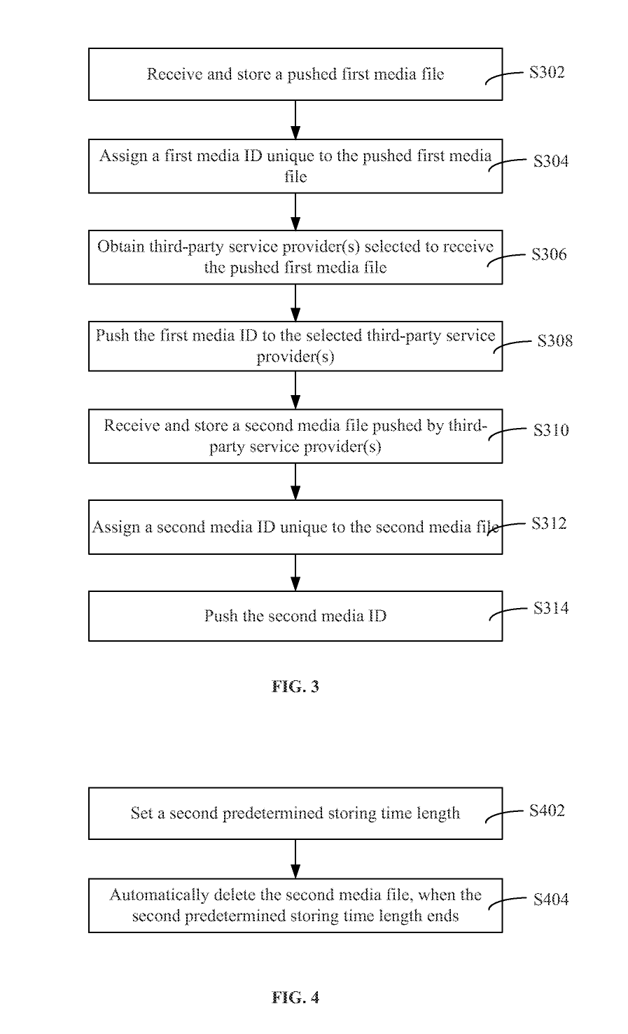

FIG. 3 depicts another exemplary method for pushing a media file in accordance with various disclosed embodiments. Compared with the method depicted in FIG. 1, the exemplary method of FIG. 3 includes further processes. For example, a second media file is returned from third-party service provider(s) and a second media ID may be stored and assigned to the second media file by a public platform server.

In Step S302, a pushed first media file is received and stored, e.g., by a server. When the public platform server receives the uploaded first media file, the first media file can be stored on the public platform server.

The first media file may include, for example, a multimedia file, a rich media file, and/or any other suitable files. Exemplary multimedia file may include various kinds of files, such as, for example, one or more files of an image file, an audio file, a video file, and/or an audio/video file, contained in a message uploaded by a user to the public platform server. For example, the multimedia file may include personal pictures of a user, user's own video(s), others' video(s), videos for sceneries, etc. Exemplary rich media file may include one or more files of an image file, a carton (or animation) file, a text file including for example a HTML (Hypertext Markup Language) file, and/or files of Javascripts, Realvideo, Realaudio, and/or Flash.

In Step S304, a first media identifier (ID) unique to the first media file is assigned. After the public platform server has stored the first media file, the public platform server can assign the first media ID. The first media ID can be a first media numbering, e.g., V0001, or other suitable numberings. In one embodiment when the user uploads multiple media files, the public platform server may assign one first media ID unique to each one media file of the multiple media files.

In Step S306, third-party service provider(s) selected to receive the first media file is obtained, e.g., by the public platform server. For example, the third-party service provider(s) can be registered with the public platform server to obtain a corresponding service account.

After the user logins to the public platform server, a plurality of third-party service providers may be displayed on an interactive interface of the public platform. The plurality of third-party service providers can be displayed as a list. The public platform server can obtain information of one or more third-party service provider(s) that the user selected from the plurality of third-party service providers. The selected one or more third-party service provider(s) can be used to receive the first media file sent by the user.

In Step S308, the first media ID is pushed to the selected third-party service provider(s). For example, after the first media ID has been pushed to the selected third-party service provider(s), the selected third-party service provider(s) can obtain the first media file corresponding to the pushed first media ID from the public platform server.

In Step S310, a second media file pushed by one or more third-party service provider(s) is received and stored, e.g., by the public platform server. For example, the second media file pushed by the third-party service provider(s) (e.g., which can be those selected in Step 306 or other suitable third-party service provider(s) in the plurality of third-party service provider that are displayed on the interactive interface) can be a multimedia file pushed to a user according to own needs of a third-party service provider, and/or can be a returned second media file corresponding to a user's request for a search. The second media file can include, for example, a multimedia file and/or a rich media file. In some cases, the second media file can include multiple media files. In various embodiments, the second media file can be the same as or different from the first media file.

For example, when a third-party service provider wants to push image files, e.g., regarding future-3-day weather status, to all possible mobile terminal users, such image files can be used as the second media file to be pushed by the third-party service provider to all the mobile terminal users via the public platform server.

In another example, a third-party service provider may receive a user's request for a weather status search and may find image file(s) for future-5-day weather status. The third-party service provider may then return the findings of the future-5-day weather status to the user. In this case, the returned image files can be used as the second media file pushed by the third-party service provider to a user terminal of the user via the public platform server.

After the public platform server has received the second media file pushed by the third-party service provider, the second media file can be stored on the public platform server. Further, FIG. 4 depicts a flow diagram for regularly deleting the second multimedia file in accordance with various disclosed embodiments.

In Step S402, a second predetermined storing time length is set. For example, the second predetermined storing time length can be determined by a storage space and properties of the public platform server. The second predetermined storing time length can be, for example, about 3 days, about 7 days, or any other time length as desired.

In Step S404, the second media file is automatically deleted, when one second predetermined storing time length ends. By regularly deleting the stored second media file (e.g., the multimedia file) from the public platform server, the storage space of the public platform server can be saved, and the server storage function can be maintained.

Referring back to FIG. 3, in Step S312, a second media ID unique to the second media file is assigned, e.g., by the public platform server. For example, the public platform server can assign the second media ID unique to the second media file. The second media ID can be a second media numbering, e.g., GV0001, or other suitable numberings.

In one embodiment when the third-party service provider(s) pushes multiple media files, the public platform server may assign one second media ID unique to each one media file of the multiple media files. In another embodiment when the second media file is a multimedia file, a unique second multimedia ID can be assigned. In another embodiment when the first media file is a rich media file, a unique second rich media ID can be assigned.

In Step S314, the second media ID is pushed. For example, the public platform server, according to the third-party service provider's needs, can push the second media ID corresponding to the pushed second media file to a user terminal. The user terminal can obtain the second media file corresponding to the second media ID from the public platform server.

As such, the third-party service provider(s) can store the pushed second media file on the public platform server. The public platform server can assign a second media ID unique to the second media file and send the second media ID to the user terminal. The exemplary method as depicted in FIG. 3 reduces data volume of network transmission, consumes less network resources, and saves the network resources. Further, there is no need for a developer of the third-party service provider to provide external links to the second media file. Operational processes are thus simplified. In addition, the provided media files are stored on the public platform server, which allows a manual safety check to ensure information safety.

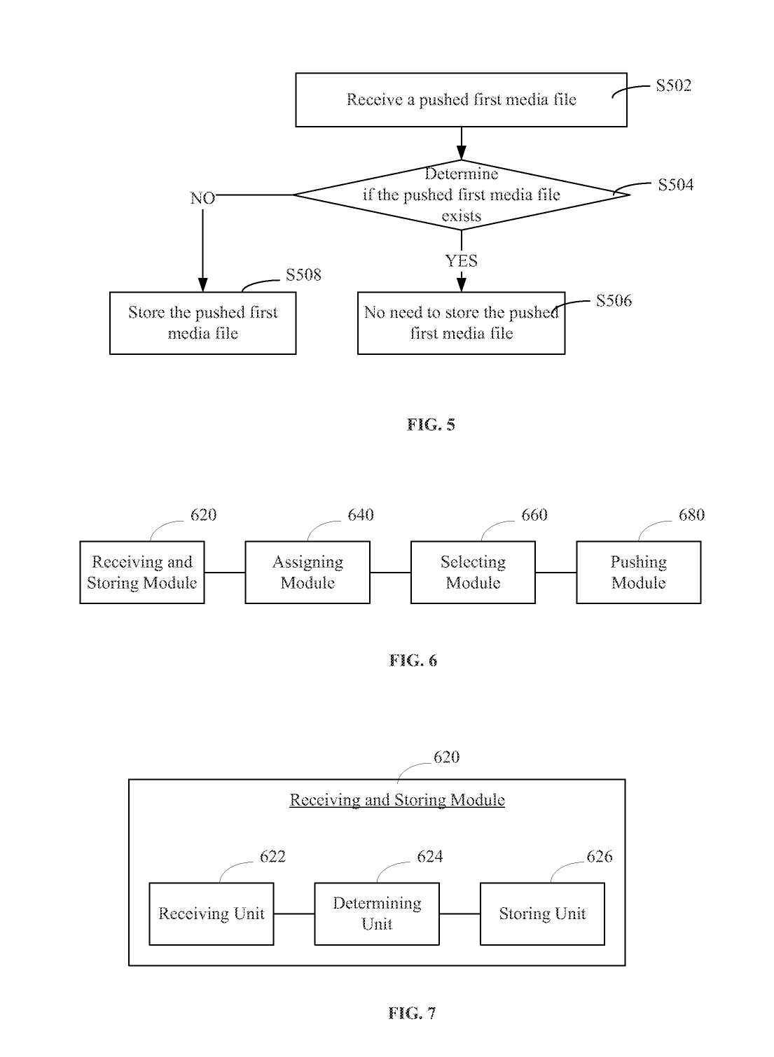

FIG. 5 depicts a flow diagram for receiving and storing a pushed media file in accordance with various disclosed embodiments.

In Step S502, a pushed first media file is received, e.g., by a server such as a public platform server. In Step S504, it is determined if the pushed first media file exists.

For example, when a user-pushed first media file has been stored on the public platform server, there is no need to further store the first media file on the public platform server. This can save storage space of the server. Determining whether the pushed first media file has been stored can include, for example, respectively calculating information digest values of the pushed first media file and the stored media file (e.g., a multimedia file). If the calculated information digest values of the pushed first media file and the stored media file are the same, the pushed first media file can be determined that exists on the public platform sever and there is no need to be further stored (e.g., Step 506). If, to the contrary, the calculated information digest values of the pushed first media file and the stored media file are different, the pushed first media file can be determined that does not exist on the public platform sever and there is a need to store the pushed first media file on the public platform sever (e.g., Step 508).

In Step S506, there is no need to store the pushed first media file on the public platform sever. In Step S508, the pushed first media file needs to be stored.

Likewise, a second media file (e.g., a multimedia file) pushed by the third-party service provider can also be determined if there is a need to store the pushed second media file on the public platform sever, using the method depicted in FIG. 5.

In various embodiments, the user-pushed (or uploaded) first media file and the third-party service-provider-pushed second media file may be the same or different. However, regardless of the first and second media files being the same or different, both of the first and second media files are respectively stored on the public platform server; the first media ID is assigned unique to the user-pushed first media file; and the second media ID is assigned unique to the third-party service-provider-pushed second media file.

It should be noted that, the first media file and the second media file are named only to differentiate files uploaded by a user or pushed by a third-party service provider. The first media file and the second media file are not limited in any manners. Likewise, corresponding first media ID and second media ID are used only for the purpose to differentiate these IDs, and the first media ID and the second media ID can be assigned in a same fashion. For example, the first media ID can be assigned as V001, while the second media ID can be assigned as V002.

FIG. 6 depicts an exemplary server for executing a method for pushing a media file in accordance with various disclosed embodiments. The exemplary server includes a receiving and storing module 620, an assigning module 640, a selecting module 660, and/or a pushing module 680.

The receiving and storing module 620 is configured to receive and store a pushed first media file. A user may use a browser/software installed on a communication device or a client terminal to register with a server of a public platform (or a public platform server) and to obtain a corresponding user registration account. Via the browser/software, the user can login to the public platform server using the user registration account and a password. The user may upload a first media file via the browser or software (e.g., in the client terminal) to the public platform server. When the public platform server receives the uploaded first media file, the first media file can be stored on the public platform server.

The first media file may include, for example, a multimedia file, a rich media file, and/or any other suitable files. Exemplary multimedia file may include various kinds of files, such as, for example, one or more files of an image file, an audio file, a video file, and/or an audio/video file, contained in a message uploaded by the user to the public platform server. For example, the multimedia file may include personal pictures of a user, user's own video(s), others' video(s), videos for sceneries, etc. Exemplary rich media file may include one or more files of an image file, a carton (or animation) file, a text file including for example a HTML (Hypertext Markup Language) file, and/or files of Javascripts, Realvideo, Realaudio, and/or Flash.

In various embodiments, the public platform can provide third-party service provider(s) with a base platform as a common interface. Such public platform can include, for example, an instant communication platform such as a Wechat platform, a microblog platform, or any other suitable platforms. When the receiving and storing module 620 of the exemplary server (e.g., the public platform server) receives the uploaded first media file, the first media file can be saved on the server.

The assigning module 640 is configured to assign a first media ID unique to the first media file. That is, after the receiving and storing module 620 has stored the first media file on the public platform server, the assigning module 640 can assign the first media ID unique to the first media file. The first media ID can be a first media numbering including, e.g., V0001, etc. In some embodiments, when a user uploads multiple media files, the exemplary public platform server can assign one media ID unique to each one media file of the multiple media files.

The selecting module 660 is configured to obtain third-party service provider(s) selected to receive the first media file. For example, the third-party service provider(s) can be registered with the public platform server to obtain a corresponding service account. After the user logins to the public platform server, a plurality of third-party service providers may be displayed on an interactive interface of the public platform. The plurality of third-party service providers can be displayed as a list. The selecting module 660 of the public platform server can obtain information of one or more third-party service provider(s) selected, by the user, from the plurality of third-party service providers displayed on the interactive interface. The selected one or more third-party service provider(s) can be used to receive the first media file sent by the user.

The pushing module 680 is configured to push the first media ID to the selected third-party service provider(s). For example, after the pushing module 680 pushes the first media ID to the selected third-party service provider(s), the selected third-party service provider(s) can obtain the first media file corresponding to the first media ID pushed from the public platform server.

As such, by using the sever to store the first media file and assign the first media ID unique to the first media file, when pushing a same first media file to a desired number of third-party service providers, it only needs to push the first media ID to the third-party service provider(s). There is no need to upload the first media file every time when pushing the first media file. This one-time uploading of the first media file reduces data volume for network transmission, consumes less network resources, and saves the network resources. Further, there is no need for the user to provide external links to the first media file. Operational processes are thus simplified.

In another embodiment, the receiving and storing module 620 is further configured to receive and store a second media file pushed by third-party service provider(s).

For example, the second media file pushed by the third-party service provider(s) can be a multimedia file pushed to a user according to own needs of a third-party service provider, and/or can be a returned second media file corresponding to a user's request for a search. The second media file can include, for example, a multimedia file and/or a rich media file. Alternatively, the second media file can include multiple media files.

In an exemplary embodiment, when a third-party service provider wants to push image files, e.g., regarding future-3-day weather status, to all mobile terminal users, such image files can be used as the second media file to be pushed by the third-party service provider.

In another exemplary embodiment, a third-party service provider may receive a user's request for a weather status search and may find image file(s) for future-5-day weather status. The third-party service provider may then return the findings of the future-5-day weather status to the user. In this case, the returned image files can be used as the second media file pushed by the third-party service provider to a user terminal of the user via the public platform server.

After the receiving and storing module 620 of the exemplary public platform server has received the second media file pushed by the third-party service provider, the second media file can be stored on the public platform server.

The assigning module 640 of the public platform server is configured to further assign a second media ID unique to the second media file. The second media ID can be a second media numbering, e.g., GV0001, or other suitable numberings. In one embodiment when the third-party service provider(s) pushes multiple media files, the assigning module 640 of the public platform server can assign one second media ID unique to each one media file of the multiple media files. In another embodiment when the third-party service provider(s) pushed second media file is a multimedia file, the assigning module 640 can assign a unique second multimedia ID. In another embodiment when the third-party service provider(s) pushed second media file is a rich-media file, the assigning module 640 can assign a unique second rich-media ID.

The pushing module 680 is configured to push the second media ID. For example, the pushing module 680 of the public platform server, according to the third-party service provider's needs, can push the second media ID corresponding to the pushed second media file to a user terminal. The user terminal can obtain the second media file corresponding to the second media ID from the public platform server.

As such, by using the exemplary public platform server, the third-party service provider(s) can store the pushed second media file on the public platform server. The public platform server can assign the second media ID unique to the second media file and send the second media ID to the user terminal. The exemplary method for pushing the media file reduces data volume for network transmission, consumes less network resources, and saves the network resources. Further, there is no need for a developer of the third-party service provider to provide external links to the second media file. Operational processes are thus simplified. In addition, the provided second media files are stored on the public platform server, which allows a manual safety check to ensure information safety.

FIG. 7 depicts an exemplary receiving and storing module in accordance with various disclosed embodiments. The exemplary receiving and storing module can be an example for the receiving and storing module 620 in FIG. 6. The receiving and storing module 620 may include a receiving unit 622, a determining unit 624, and/or a storing unit 626.

The receiving unit 622 is configured to receive the pushed first media file. The determining unit 624 is configured to determine if the pushed first media file exists. The storing unit 626 is configured not to store the pushed first media file, when the pushed first media file is determined that exists. Alternatively, the storing unit 626 is configured to store the pushed first media file, when the pushed first media file is determined that does not exist.

For example, when a user-pushed first media file has been stored on the public platform server, there is no need to further store the first media file on the public platform server. This can save storage space of the server.

The determining unit 624 can determine whether the pushed first media file has been stored by respectively calculating information digest values of the pushed first media file and the stored media file (e.g., a multimedia file). If the calculated information digest values the pushed first media file and the stored media file are the same, the pushed first media file has been determined that exists on the public platform sever and there is no need to be further stored. If, to the contrary, the calculated information digest values of the pushed first media file and the stored media file are different, the pushed first media file has been determined that does not exist on the public platform sever and there is a need to store the pushed first media file on the public platform sever. The storing unit 626 can be used to store the pushed first media file on the public platform sever.

Likewise, a second media file (e.g., a multimedia file) pushed by the third-party service provider can also be determined if there is a need to store the pushed second media file on the public platform sever.

In various embodiments, the user-pushed first media file and the third-party service-provider-pushed second media file may be the same or different. However, regardless of the first and second media files being the same or different, both of the first and second media files are respectively stored on the public platform server; the first media ID is assigned unique to the user-pushed first media file; and the second media ID is assigned unique to the third-party service-provider-pushed second media file.

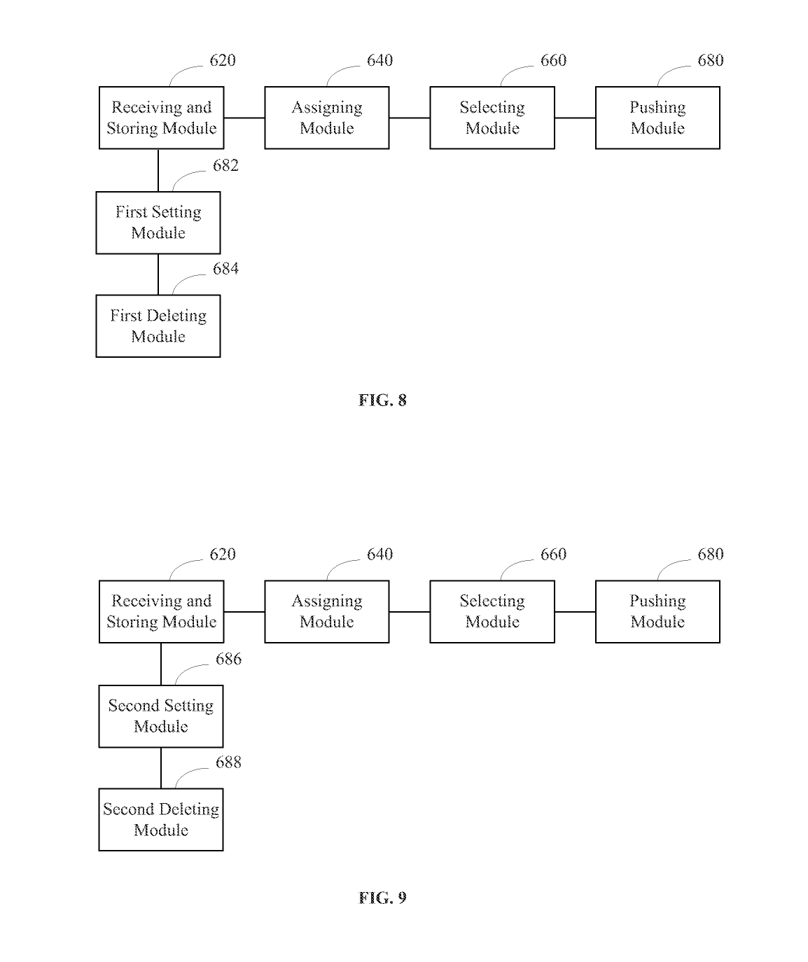

FIG. 8 depicts another exemplary server in accordance with various disclosed embodiments. Compared with the exemplary server depicted in FIGS. 6-7, in addition to having the receiving and storing module 620, the assigning module 640, the selecting module 660, the pushing module 680, as depicted in FIGS. 6-7, the exemplary server in FIG. 8 further includes a first setting module 682, and a first deleting module 684.

The first setting module 682 is configured to set a first predetermined storing time length. For example, the first predetermined storing time length can be determined by storage space and properties of the exemplary public platform server. The first predetermined storing time length can be, for example, about 3 days, about 7 days, or any other suitable time length as desired.

The first deleting module 684 is configured to automatically delete the first media file, when one first predetermined storing time length ends. By regularly deleting the stored first media file, e.g. at regular intervals, from the public platform server, the storage space of the public platform server can be saved, and the storage function of the public platform server can be maintained.

FIG. 9 depicts another exemplary server in accordance with various disclosed embodiments. Compared with the exemplary server depicted in FIG. 8, the exemplary server of FIG. 9 can further include a second setting module 686, and/or a second deleting module 688.

The second setting module 682 is configured to set a second predetermined storing time length. For example, the second predetermined storing time length can be determined by the storage space and properties of the public platform server. The first predetermined storing time length can be, for example, about 3 days, about 7 days, or any other suitable time length as desired.

The second deleting module 688 is configured to automatically delete the second media file, when one second predetermined storing time length ends. By regularly deleting the stored second media file, e.g. at regular intervals, from the public platform server, the storage space of the public platform server can be saved, and the storage function of the public platform server can be maintained.

In other embodiments, another exemplary server can include a receiving and storing module 620, an assigning module 640, a selecting module 660, a pushing module 680, a first setting module 682, a first deleting module 684, a second setting module 686, and/or a second deleting module 688. Each module can function as described in FIGS. 7-9.

In various embodiments, the disclosed modules for the exemplary servers as depicted above can be configured in one device or configured in multiple devices as desired. The modules disclosed herein can be integrated in one module or in multiple modules for pushing media files. Each of the modules disclosed herein can be divided into one or more sub-modules, which can be recombined in any manners.

The disclosed embodiments can be examples only. One of ordinary skill in the art would appreciate that suitable software and/or hardware (e.g., a universal hardware platform) may be included and used to perform the disclosed methods. For example, the disclosed embodiments can be implemented by hardware only, which alternatively can be implemented by software products only. The software products can be stored in a storage medium (e.g., as shown in FIG. 11). The software products can include suitable commands to enable a terminal device (e.g., including a mobile phone, a personal computer, a server, or a network device, etc.) to implement the disclosed embodiments.

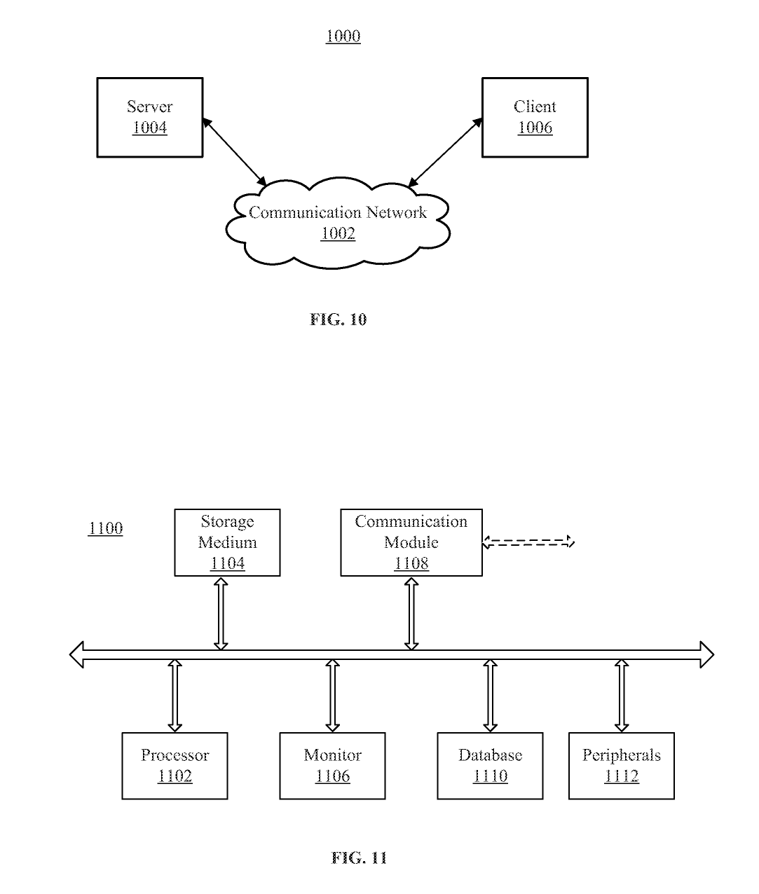

FIG. 10 depicts an exemplary environment 1000 incorporating various disclosed embodiments. As shown in FIG. 10, the environment 1000 may include a server 1004, a client 1006, and a communication network 1002. The server 1004 and the client 1006 may be coupled through the communication network 1002 for information exchange, such as media file pushing, instant message communication, Wechat communication, microblog communication. Although only one client 1006 and one server 1004 is shown in the environment 1000, any number of clients 1006 or servers 1004 may be included, and other devices may also be included.

Communication network 1002 may include any appropriate type of communication network for providing network connections to the server 1004 and client 1006 or among multiple servers 1004 or clients 1006. For example, communication network 1002 may include the Internet or other types of computer networks or telecommunication networks, either wired or wireless.

The client 1006 may refer to any appropriate user terminal with certain computing capabilities, such as a personal computer (PC), a work station computer, a server computer, a hand-held computing device (tablet), a smart phone or mobile phone, or any other user-side computing device.

The server 1004 may refer to one or more server computers configured to provide certain server functionalities, such as media file pushing, database management, search engines, etc. The server may also include one or more processors to execute computer programs in parallel. For example, the server 1004 may be a public platform server as disclosed herein.

The server 1004 and/or client 1006 may be implemented on any appropriate computing platform. FIG. 11 shows a block diagram of an exemplary computing system 1100 capable of implementing the server 1004 and/or client 1006.

As shown in FIG. 11, the computing system 1100 may include a processor 1102, a storage medium 1104, a monitor 1106, a communication module 1108, a database 1110, and peripherals 1112. Certain devices may be omitted and other devices may be included.

The processor 1102 may include any appropriate processor or processors. Further, processor 1102 can include multiple cores for multi-thread or parallel processing. Storage medium 1104 may include memory modules, such as ROM, RAM, flash memory modules, and erasable and rewritable memory, and mass storages, such as CD-ROM, U-disk, and hard disk, etc. Storage medium 1104 may store computer programs for implementing various processes, when executed by the processor 1102.

Further, the peripherals 1112 may include I/O devices such as keyboard and mouse, and the communication module 1108 may include network devices for establishing connections through the communication network 1002. Database 1110 may include one or more databases for storing certain data and for performing certain operations on the stored data, such as database searching.

Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

Methods and servers are provided for pushing a media file. In an exemplary method, a first media file can be received and stored on a server. A first media identifier (ID) unique to the first media file can be assigned by the server. One or more third-party service providers selected from a plurality of third-party service providers can be obtained to receive the first media file. The first media ID can be pushed to the selected one or more third-party service providers.

An exemplary server can include a receiving and storing module, an assigning module, a selecting module, and/or a pushing module for pushing the media file. The receiving and storing module can be configured to receive and store a first media file uploaded by a user from a user terminal. The assigning module can be configured to assign a first media identifier (ID) unique to the pushed first media file. The selecting module can be configured to select one or more third-party service providers from a plurality of third-party service providers to receive the first media file. The pushing module can be configured to push the first media ID to the selected one or more third-party service providers such that the one or more third-party service providers can obtain the first media file corresponding to the first media ID.

As disclosed, by storing the first media file and assigning the first media ID unique to the first media file, when pushing the same first media file to a desired number of third-party service providers, the disclosed methods and servers only need to push the first media ID to the third-party service provider(s). There is no need to upload the first media file every time when pushing the first media file. This one-time uploading of the first media file reduces data volume for network transmission, consumes less network resources, and saves the network resources. Further, there is no need for the user to provide external links to the first media file. Operational processes are thus simplified.

What is claimed is:

1. A method for pushing a media file, comprising:
receiving and storing a pushed first media file;
assigning a first media identifier (ID) unique to the pushed first media file;
obtaining one or more third-party service providers selected from a plurality of third-party service providers to receive the pushed first media file; and
pushing the first media ID to the selected one or more third-party service providers.

2. The method of claim 1, further comprising:
receiving and storing a second media file pushed by the one or more third-party service providers;
assigning a second media ID unique to the second media file; and
pushing the second media ID.

3. The method of claim 1, wherein receiving and storing the pushed first media file comprises:
receiving the pushed first media file;
determining if the pushed first media file exists; and
storing the pushed first media file, when the pushed first media file is determined that does not exist, wherein no storing is performed, when the pushed first media file is determined that exists.

4. The method of claim 1, further comprising:
setting a first predetermined storing time length; and
automatically deleting the pushed first media file, when the first predetermined storing time length ends.

5. The method of claim 2, further comprising:
setting a second predetermined storing time length; and
automatically deleting the second media file, when the second predetermined storing time length ends.

6. The method of claim 1, wherein the pushed first media file comprises a multimedia file, a rich media file, or multiple media files.

7. The method of claim 2, wherein the second media file comprises a multimedia file, a rich media file, or multiple media files.

8. A server for pushing a media file, comprising:
a receiving and storing module, configured to receive and store a pushed first media file;
an assigning module, configured to assign a first media identifier (ID) unique to the pushed first media file;
a selecting module, configured to select one or more third-party service providers from a plurality of third-party service providers to receive the pushed first media file; and
a pushing module, configured to push the first media ID to the selected one or more third-party service providers.

9. The server of claim 8, wherein:
the receiving and storing module is further configured to receive and store a second media file pushed by the one or more third-party service providers;
the assigning module is further configured to assign a second media ID unique to the second media file; and
the pushing module is further configured to push the second media ID.

10. The server of claim 8, wherein the receiving and storing module comprises:
a receiving unit, configured to receive the pushed first media file;
a determining unit, configured to determine if the pushed first media file exists; and
a storing unit, configured to store the pushed first media file, when the pushed first media file is determined that does not exist, wherein no storing is performed, when the pushed first media file is determined that exists.

11. The server of claim 8, further comprising:
a first setting module, configured to set a first predetermined storing time length; and
a first deleting module, configured to automatically delete the pushed first media file, when the first predetermined storing time length ends.

12. The server of claim 9, further comprising:
a second setting module, configured to set a second predetermined storing time length; and
a second deleting module, configured to automatically delete the second media file, when the second predetermined storing time length ends.

13. The server of claim 8, wherein the pushed first media file comprises a multimedia file, a rich media file, or multiple media files.

14. The server of claim 9, wherein the second media file comprises a multimedia file, a rich media file, or multiple media files.

15. The server of claim 8, wherein the server comprises a server of a public platform comprising a Wechat platform, or a microblog platform.
